(19) United States
(12) Patent Application Publication
(10) Pub. No.: US 2026/0140632 A1
(43) Pub. Date: May 21, 2026

(54) LOAD BALANCING AMONG DATA STORAGE DEVICES USING REPORTED BANDWIDTH

(71) Applicant: Sandisk Technologies, Inc., Milpitas, CA (US)

(72) Inventors: Bishwajit Dutta, Bangalore (IN); Hitesh Golechchha, Bangalore (IN)

(21) Appl. No.: 18/950,336

(22) Filed: Nov. 18, 2024

(51) Int. Cl. G06F 3/06; G06F 9/50

(52) U.S. Cl. CPC G06F 3/0613; G06F 3/0659; G06F 3/0683; G06F 9/505

(57) ABSTRACT

Systems, methods, and data storage devices for load balancing among data storage devices using reported bandwidth. A host or controller system receives bandwidth change notifications from connected storage devices. Based on the bandwidth change notification, the host determines a bandwidth at capacity value for each storage device, sorts the devices by their bandwidth at capacity values, and selects a routing subset to provide a target bandwidth for the system. The host then sends storage commands to the routing subset until another bandwidth change notification is received and a new routing subset may be selected.

### TECHNICAL FIELD

The present disclosure generally relates to bandwidth management for non-volatile memory and, more particularly, to load balancing in multi-device storage systems for uniform host input/output performance.

### BACKGROUND

Data storage devices, such as disk drives (solid-state drives, hard disk drives, hybrid drives, tape drives, etc.), universal serial bus (USB) flash drives, secure digital (SD) cards and SD extended capacity (SDXC) cards, and other form factors, may be used for storing data on behalf of a host, host system, or host device. These storage devices may include integrated storage devices built into the enclosure of the host device, removable storage devices mating with the host device through a physical interface connector (directly or through an interface cable), and network storage devices communicating with the host device using network protocols over a wired or wireless network connection. For many storage applications, multiple storage devices may be configured to support one or more hosts to provide increased capacity and performance to support host applications. For example, multi-device storage systems, such as flash arrays, network attached storage, tiered storage system, etc., include multiple storage devices arranged in an array of drives interconnected by a common communication fabric and, in many cases, controlled by a storage controller, redundant array of independent disks (RAID) controller, network interface controller, or general controller, for coordinating storage, communication, and system activities across the array of drives, such as solid state drives (SSDs).

Data may be written to memory cells in SSDs in different configurations. A single-level cell (SLC) NAND flash memory stores one bit of data per cell of flash media. A multi-layer cell (MLC) NAND flash memory typically stores two bits of data per cell of flash media. A triple-level cell (TLC) NAND flash memory stores three bits of data per cell of flash media, and a quad-level cell (QLC) NAND flash memory stores four bits of data per cell of flash media. While MLC, TLC and QLC configurations enable a larger amount of data that can be stored in a NAND flash device of similar size, the endurance of the storage device deteriorates as more dense configurations are used. Additionally, while a SLC memory configuration provides higher cell endurance and lower power consumption, SLC memory involves higher manufacturing costs and lower densities. Individual SSDs may incorporate different types of flash memory (such as both SLC and MLC blocks) and may include internal flash management schemes implemented in garbage collection for internal relocation within and between memory types. For example, such SSDs may implement various compaction schemes to consolidate valid data and free erase blocks for reuse, such as SLC to SLC compaction, SLC to MLC relocation, and MLC to SLC compaction.

The backend bandwidth of a flash storage device is fixed and is used both for host input/output (I/O) and garbage collection that includes internal relocation. While the host in a multi-device storage environment may have control over host I/O, it may have less control over garbage collection and this becomes even more complicated in multi-host systems where each host may have only limited control over the total host I/O being directed to any given drive. Further, while the operations necessary to relocate a block are relatively fixed, the yield of valid units varies widely based on the validity count (VC) of the block being compacted. For example, compaction of blocks that are 80% valid only yields one available block for very five blocks compacted, whereas compaction of blocks that are only 20% valid has a far greater yield and, therefore, performance efficiency. Depending on the usage patterns and garbage collection of the drive, drives may have blocks with wide ranging validity counts that are not easily conveyed to host systems. Therefore, it may be difficult for the host to predict the actual bandwidth available from each storage device and assure that a constant host I/O processing load can be maintained, even if each storage device meets its guaranteed processing service level.

Dynamic selection of data storage devices based on available backend bandwidth reported in real-time may be advantageous. An efficient method for load balancing among multiple devices to support constant bandwidth based on reported bandwidth may be needed.

### SUMMARY

Various aspects for load balancing among multiple data storage devices using reported bandwidth are described. More specifically, systems, methods, and data storage devices reporting bandwidth changes may allow a load balancer to sort and allocate storage commands among data storage devices to maintain a constant host I/O bandwidth through the backend memory interfaces of the individual data storage devices.

One general aspect includes a system that includes a storage interface configured to provide storage commands to a plurality of data storage devices, at least one memory, and at least one processor configured to, alone or in combination: receive, from the plurality of data storage devices, bandwidth change notifications corresponding to changes in a host storage operation bandwidth for a non-volatile storage medium of that data storage device; determine, based on the bandwidth change notifications, an available capacity at bandwidth value for that data storage device; sort, based on the available capacity at bandwidth values, storage device identifiers for the plurality of data storage devices; select, based on the sorted storage device identifiers, a routing subset of the plurality of data storage devices, where a number of devices in the routing subset of the plurality of data storage devices is less than a number of devices in the plurality of data storage devices; and selectively send host storage commands to the routing subset of the plurality of data storage devices.

Implementations may include one or more of the following features. The bandwidth change notifications may include a bandwidth state for that data storage device and selecting the routing subset of the plurality of data storage devices may be based on a comparison of the bandwidth states of the plurality of data storage devices. At least one data storage device of the plurality of data storage devices may be configured for constant bandwidth zones corresponding to the bandwidth state of that data storage device and determining the available capacity at bandwidth value for that at least one data storage device may be based on an estimated operating period at that bandwidth state. The bandwidth change notifications may include the available capacity at bandwidth value for that data storage device. The at least one processor may be further configured to, alone or in combination: receive, from a corresponding data storage device of the plurality of data storage devices, each bandwidth change notification as an interrupt notification based on a balancing cycle trigger determined by the corresponding data storage device; initiate, responsive to receiving at least one bandwidth change notification, sorting the storage device identifiers and selecting the routing subset; and use, for an operating period extending until receiving another bandwidth change notification, the routing subset for selectively sending host storage commands. The at least one processor may be further configured to, alone or in combination: determine a target bandwidth for aggregate storage operations across the plurality of data storage devices; and aggregate the available capacity at bandwidth values for sorted storage device identifiers until the target bandwidth is met to select the routing subset of the plurality of data storage devices. The system may further include the plurality of data storage devices, where each data storage device of the plurality of data storage devices may include: a host interface for that data storage device configured for communication with the at least one processor; the non-volatile storage medium for that data storage device; at least one storage device processor for that data storage device configured to, alone or in combination: process storage commands received by the host interface; execute storage operations to the non-volatile storage medium with a fixed bandwidth divided between host storage operations and relocation operations; determine a change in available bandwidth for host storage operations; and send the bandwidth change notification through the host interface. The at least one storage device processor for that data storage device may be further configured to, alone or in combination: determine, for a plurality of data blocks in the non-volatile storage medium, validity count values corresponding to an amount of valid and invalid data in that data block; select, based on the validity count values, data blocks for relocation operations; determine, based on the validity count values and a number of data blocks for relocation, the capacity at bandwidth value; and include the capacity at bandwidth value in the bandwidth change notification. The at least one storage device processor for that data storage device may be further configured to, alone or in combination: determine, based on available data blocks, a bandwidth state; determine, based on the change in the available bandwidth for host storage operations, a balancing cycle trigger; initiate, responsive to the balancing cycle trigger, sending the bandwidth change notification; and include the bandwidth state in the bandwidth change notification. The system may further include a host device including the storage interface, the at least one memory, and the at least one processor, where the plurality of data storage device support storage commands from a plurality of host devices.

Another general aspect includes a computer-implemented method that includes: receiving, from a plurality of data storage devices, bandwidth change notifications corresponding to changes in a host storage operation bandwidth for a non-volatile storage medium of that data storage device; determining, based on the bandwidth change notifications, an available capacity at bandwidth value for that data storage device; sorting, based on the available capacity at bandwidth values, storage device identifiers for the plurality of data storage devices; selecting, based on the sorted storage device identifiers, a routing subset of the plurality of data storage devices, where a number of devices in the routing subset of the plurality of data storage devices is less than a number of devices in the plurality of data storage devices; and selectively sending host storage commands to the routing subset of the plurality of data storage devices.

Implementations may include one or more of the following features. The computer-implemented method may include: determining, from the bandwidth change notifications, a bandwidth state for that data storage device; and comparing the bandwidth states of the plurality of data storage devices to select the routing subset of the plurality of data storage devices. At least one data storage device of the plurality of data storage devices may be configured for constant bandwidth zones corresponding to the bandwidth state of that data storage device; and determining the available capacity at bandwidth value for that at least one data storage device may be based on an estimated operating period at that bandwidth state. The bandwidth change notifications may include the available capacity at bandwidth value for that data storage device. The computer-implemented method may include: receiving, from a corresponding data storage device of the plurality of data storage devices, each bandwidth change notification as an interrupt notification based on a balancing cycle trigger determined by the corresponding data storage device; initiating, responsive to receiving at least one bandwidth change notification, sorting the storage device identifiers and selecting the routing subset; and using, for an operating period extending until receiving another bandwidth change notification, the routing subset for selectively sending host storage commands. The computer-implemented method may include: determining a target bandwidth for aggregate storage operations across the plurality of data storage devices; and aggregating the available capacity at bandwidth values for sorted storage device identifiers until the target bandwidth is met to select the routing subset of the plurality of data storage devices. The computer-implemented method may include: processing, by a data storage device from the plurality of data storage devices, storage commands received from at least one host device; executing, by the data storage device, storage operations to the non-volatile storage medium based on a fixed bandwidth divided between host storage operations and relocation operations; determining, by the data storage device, a change in available bandwidth for host storage operations; and sending, by the data storage device, the bandwidth change notification to the at least one host device. The computer-implemented method may include: determining, by the data storage device and for a plurality of data blocks in the non-volatile storage medium, validity count values corresponding to an amount of valid and invalid data in that data block; selecting, by the data storage device and based on the validity count values, data blocks for relocation operations; determining, by the data storage device and based on the validity count values and a number of data blocks for relocation, the capacity at bandwidth value; and including, by the data storage device, the capacity at bandwidth value in the bandwidth change notification. The computer-implemented method may include: determining, by the data storage device and based on available data blocks, a bandwidth state; determining, by the data storage device and based on the change in the available bandwidth for host storage operations, a balancing cycle trigger; initiating, by the data storage device and responsive to the balancing cycle trigger, sending the bandwidth change notification; and including, by the data storage device, the bandwidth state in the bandwidth change notification.

Still another general aspect includes a system that includes: means for receiving, from a plurality of data storage devices, bandwidth change notifications corresponding to changes in a host storage operation bandwidth for a non-volatile storage medium of that data storage device; means for determining, based on the bandwidth change notifications, an available capacity at bandwidth value for that data storage device; means for sorting, based on the available capacity at bandwidth values, storage device identifiers for the plurality of data storage devices; means for selecting, based on the sorted storage device identifiers, a routing subset of the plurality of data storage devices, where a number of devices in the routing subset of the plurality of data storage devices is less than a number of devices in the plurality of data storage devices; and means for selectively sending host storage commands to the routing subset of the plurality of data storage devices.

The various embodiments advantageously apply the teachings of data storage devices and/or storage systems to improve the functionality of such computer systems. The various embodiments include operations to overcome or at least reduce the issues previously encountered in storage systems and, accordingly, are more efficient and/or reliable than other computing systems. That is, the various embodiments disclosed herein include hardware and/or software with functionality to improve the data storage system performance, such as by a providing load balancing using reported bandwidth and an algorithm for maintaining constant bandwidth. Accordingly, the embodiments disclosed herein provide various improvements to storage networks and/or storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 schematically illustrates a storage system with host device configured for load balancing across a plurality of storage devices.

FIGS. 2A and 2B schematically illustrate two prior art approaches used by data storage devices to balance fixed bandwidth for host writes and internal relocation.

FIG. 3 is a flowchart of an example method for load balancing among data storage devices using reported bandwidth that may be used by the storage system of FIG. 1.

FIG. 4 schematically illustrates a host device of the storage system of FIG. 1.

FIG. 5 schematically illustrates some elements of a data storage device of FIG. 1 in more detail.

FIG. 6 schematically illustrates some elements of a host device of FIG. 1 in more detail.

FIG. 7 is a flowchart of an example method of load balancing by a host device in response to bandwidth change notifications from the data storage devices.

FIG. 8 is a flowchart of an example method of reporting bandwidth changes by a data storage device.

### DETAILED DESCRIPTION

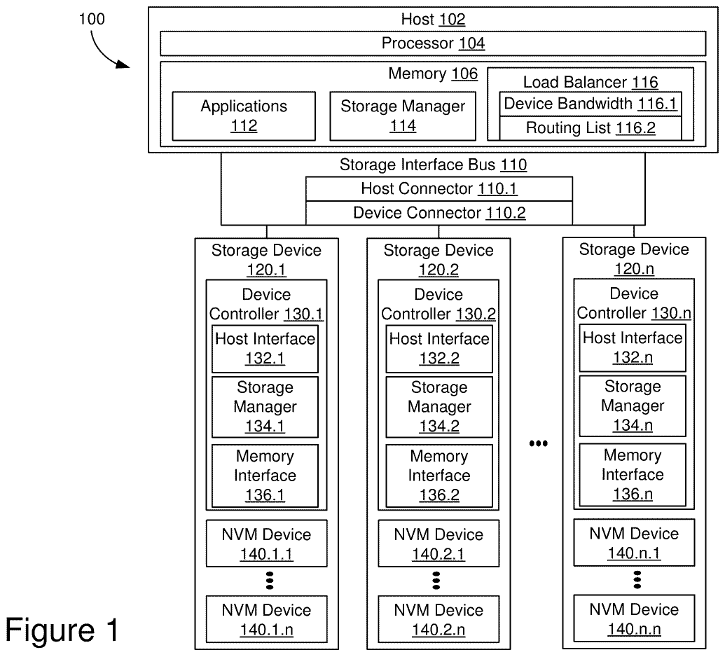

FIG. 1 shows an embodiment of an example data storage system 100 with data storage devices 120 interconnected by a storage interface bus 110 to host device 102. While some example features are illustrated, various other features have not been illustrated for the sake of brevity and so as not to obscure pertinent aspects of the example embodiments disclosed herein. To that end, as a non-limiting example, data storage system 100 includes one or more data storage devices 120 (also sometimes called information storage devices, disk drives, or drives) in communication with one or more host devices 102. In some embodiments, host device 102 may be a user device with an embedded computing system, such as an automobile, video camera, mobile phone, tablet computer, smart television, smart appliance, portable game device, printer, or other consumer electronic device. In some embodiments, storage device 120 may be a removable storage device, such as a universal serial bus (USB) flash drive, secure digital (SD) card, extended capacity (SDXC) SD card, or other removable storage device.

In some embodiments, storage device 120 may be configured in a server or storage array blade or similar storage unit for use in data center storage racks or chassis. Storage device 120 may interface with one or more host devices 102 and provide data storage and retrieval capabilities for or through those host systems. In some embodiments, host device 102 may support one or more client systems or devices configured to access data in or about storage device 120. For example, clients may include one or more applications that access data from storage device 120 through host device 102 and/or through a network or network fabric. In some embodiments, storage device 120 may be configured in a storage hierarchy that includes storage nodes, storage controllers, and/or other intermediate components between storage device 120 and host device 102. For example, each storage controller may be responsible for a corresponding set of storage nodes and their respective storage devices may be connected through a corresponding internal bus architecture including storage interface bus 110 or may be connected through a corresponding backplane network and/or network fabric, though only storage devices 120 and host device 102 are shown.

In the embodiment shown, a number of storage devices 120.1-120.n are attached to a common storage interface bus 110 for host communication with host device 102. For example, storage devices 120 may include a number of drives arranged in a storage array, such as storage devices sharing a common rack, unit, or blade in a data center or the SSDs in an all flash array. As another example, host device 102 may include a host connector 110.1, such as a peripheral component interface express (PCIe) connector, USB slot, memory card slot/reader (for Memory Stick, MultiMedia Card, SD, SDXC, etc. memory cards), etc., that provides a physical connector configured to mate with a corresponding storage device connector 110.2. In some embodiments, host connector 110.1 may define a slot or port providing a wired internal connection to a host bus or storage interface controller. In some embodiments, device connector 110.2 may include a portion of a storage device housing or projection therefrom that removably inserts into the slot or port in host connector 110.1 to provide a physical attachment and electrical connection for host-device communication. In some embodiments, an intervening wire, extender, switch, or similar device compatible with host connector 110.1 and device connector 110.2 may be inserted between host connector 110.1 and device connector 110.2 without materially changing the host-device interface or operation of storage interface 110.

In some embodiments, storage interface bus 110 may be configured to use network communication protocols. Host connector 110.1 and device connector 110.2 may include any type of physical connector compatible with one or more network and/or internet protocols. For example, host connector 110.1 and device connector 110.2 may include ethernet, PCIe, Fibre Channel, small computer serial interface (SCSI), serial attached SCSI (SAS), or another network-capable interface. In some embodiments, storage devices 120 may communicate through a backplane network, network switch(es), and/or other hardware and software components accessed through storage interface bus 110 for reaching host device 102. For example, storage interface bus 110 may include or interconnect with a plurality of physical port connections and intermediate components that define physical, transport, and other logical channels for establishing communication with the different components and subcomponents for establishing a communication channel between host device 102 and storage devices 120. In some embodiments, storage interface 110 may provide a primary host interface for storage device management and host data transfer, as well as a control interface that includes limited connectivity to the host for low-level control functions, such as through a baseboard management controller (BMC).

In some embodiments, data storage devices 120 are, or include, solid-state memory devices. Each data storage device 120 may include a non-volatile memory (NVM) or storage device controller 130 based on compute resources (processor and memory) and a plurality of NVM or media devices 140 for data storage (e.g., one or more NVM device(s), such as one or more flash memory devices). In some embodiments, storage device controller 130 may include a host interface controller 132, a storage manager 134, and one or more memory interface controllers 136. For example, host interface controller 132 may include a physical subsystem, such as an application specific integrated circuit (ASIC) or system on a chip (SOC), and/or logic or firmware running on the general compute resources of storage device controller 130 for configuring and controlling communication with host device 102 over storage interface bus 110. Storage manager 134 may include configuration, background, and storage processing operations running on the general compute resources of storage device controller 130 to coordinate operation of storage device 120, host interface 132, and memory interface 136. Memory interface 136 may include a physical memory bus and related resources for connecting to NVM devices 140.1-140.n, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors, such as device connector 110.2, for interconnecting with storage interface bus 110.

In some embodiments, a respective data storage device 120 may include a single medium device while in other embodiments data storage device 120 includes a plurality of media devices. In some embodiments, media devices 140 may include NAND-type flash memory or NOR-type flash memory. In some embodiments, data storage device 120 may include one or more hard disk drives (HDDs). In some embodiments, data storage devices 120 may include a flash memory device, which in turn includes one or more flash memory die, one or more flash memory packages, one or more flash memory channels, or the like. However, in some embodiments, one or more data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.).

In some embodiments, each storage device 120 includes storage device controller 130, which includes one or more processing units (also sometimes called central processing units (CPUs), processors, microprocessors, or microcontrollers) configured to execute instructions in one or more programs. In some embodiments, the one or more processors are shared by one or more components within, and in some cases, beyond the function of the device controller. In some embodiments, device controllers 130 may include firmware for controlling data written to and read from media devices 140, one or more storage (or host) interface protocols for communication with other components, as well as various internal functions, such as garbage collection, wear leveling, media scans, and other memory and data maintenance. For example, device controllers 130 may include firmware for running the NVM layer of an NVMe storage protocol alongside media device interface and management functions specific to the storage device. Media devices 140 are coupled to device controllers 130 through connections that typically convey commands in addition to data, and optionally convey metadata, error correction information and/or other information in addition to data values to be stored in media devices and data values read from media devices 140. Media devices 140 may include any number (i.e., one or more) of memory devices including, without limitation, non-volatile semiconductor memory devices, such as flash memory device(s).

In some embodiments, media devices 140 in storage device 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. Storage locations may include physical and/or logical locations on storage devices 120 and may be described and/or allocated at different levels of granularity depending on the storage medium, storage device/system configuration, and/or context. For example, storage locations may be allocated at a host logical block address (LBA) data unit size and addressability for host read/write purposes but managed as pages with storage device addressing managed in the media flash translation layer (FTL) in other contexts. Media segments may include physical storage locations on storage devices 120, which may also correspond to one or more logical storage locations. In some embodiments, media segments may include a continuous series of physical storage location, such as adjacent data units on a storage medium, and, for flash memory devices, may correspond to one or more media erase or programming blocks. A logical data group may include a plurality of logical data units that may be grouped on a logical basis, regardless of storage location, such as data objects, files, or other logical data constructs composed of multiple host blocks. In some configurations, logical and/or physical zones may be assigned within storage device 120 as groups of data blocks allocated for specified host data management purposes.

In some embodiments, host, host system, or host device 102 may be coupled to data storage system 100 through a network interface that is part of host fabric network that includes storage interface 110 as a host fabric interface. In some embodiments, multiple host devices 102 (only one of which is shown in FIG. 1) and/or clients are coupled to data storage system 100 through the fabric network, which may include a storage network interface or other interface capable of supporting communications with multiple host systems. In some embodiments, the fabric network may operate over a wired and/or wireless network (e.g., public and/or private computer networks in any number and/or configuration) which may be coupled in a suitable way for transferring data. For example, the network may include any means of a conventional data communication network such as a local area network (LAN), a wide area network (WAN), a telephone network, such as the public switched telephone network (PSTN), an intranet, the internet, or any other suitable communication network or combination of communication networks.

Host device 102 may be any suitable computer device, such as a computer, a computer server, a laptop computer, a tablet device, a netbook, an internet kiosk, a personal digital assistant, a mobile phone, a smart phone, a gaming device, a smart appliance, a camera or video camera, consumer electronics device, or any other computing device. Host device 102 is sometimes called a host, client, or client system, depending on respective roles, configurations, and contexts. In some embodiments, host device 102 is distinct from a storage controller, storage node, or storage interface component housing or receiving storage device 120. In some embodiments, host device 102 may be any computing device configured to store and access data in storage device 120.

Host device 102 may include one or more central processing units (CPUs) or processors 104 for executing, alone or in combination, compute operations or instructions for accessing storage devices 120 through storage interface bus 110. In some embodiments, processor 104 may be associated with operating memory 106 for executing both storage operations and a storage interface protocol compatible with storage interface 110 and storage devices 120. In some embodiments, a separate storage interface unit (not shown) may provide the storage interface protocol and related processor and memory resources. From the perspective of each storage device 120, storage interface bus 110 may be referred to as a host interface and provides a host data path between each storage device 120 and host device 102.

Host device 102 may include memory 106 configured to support various data access and management functions, generally in support of one or more applications 112. Memory 106 may include a random access memory (RAM) or another type of dynamic storage device that stores information and instructions for execution by processor 104 and/or a read only memory (ROM) or another type of static storage device that stores static information and instructions for use by processor 104 and/or any suitable storage element such as a hard disk or a solid state storage element. For example, memory 106 may include one or more dynamic random access memory (DRAM) devices for use by host device 102 for command, management parameter, and/or host data storage and transfer to and from storage device 120. In some embodiments, storage devices 120 may be configured for direct memory access (DMA), such as using remote direct memory access (RDMA) protocols, over storage interface 110 to interact with host device 102.

In some embodiments, host device 102 may include one or more applications 112 instantiated in host memory 106 for execution by host processor 104. Applications 112 may include and/or be configured to access one or more storage management functions of host storage manager 114. Host storage manager 114 may include applications, services, libraries, and/or corresponding interfaces for managing the contents and operation of each storage device 120 on behalf of host device 102. For example, host storage manager 114 may include services for monitoring storage device parameters, such as total capacity, capacity used, and capacity available, tracking storage device I/O history, performance, and workload, and initiating host storage maintenance functions, such as media scans, defragmentation, host data transfer or reorganization, etc. Host storage manager 114 may include or interface with a storage driver configured for one or more storage interface protocols for communicating with storage devices 120 over storage interface bus 110. In some configurations, host storage manager 114 may include or access a load balancer 116 configured to allocate host storage commands among storage devices 120.1-120.n. For example, load balancer 116 may receive bandwidth change notifications from storage devices 120 to track backend device bandwidth 116.1 corresponding to the allocation of memory interface bandwidth to host storage operations, as opposed to internal garbage collection. In some configurations, device bandwidth 116.1 may include both the current bandwidth and a capacity at bandwidth value telling load balancer 116 how long the bandwidth is available before another bandwidth change is likely. Using reported device bandwidth, load balancer 116 may determine a routing list 116.2 that is a current subset of storage devices 120 that should receive host storage commands to maintain a target bandwidth throughput for the host system. Maintaining a target bandwidth throughput, regardless of the host I/O rating or service levels guaranteed by each device, may be valuable for managing storage and processing intensive applications, such as training and operating machine learning models. Load balancer 116 may be configured to recalculate the routing list each time a bandwidth change notification is received from one of the storage devices and another load balancing cycle is triggered.

In some embodiments, data storage system 100 includes one or more processors, one or more types of memory, a display and/or other user interface components such as a keyboard, a touch screen display, a mouse, a track-pad, and/or any number of supplemental devices to add functionality. In some embodiments, data storage system 100 does not have a display and other user interface components.

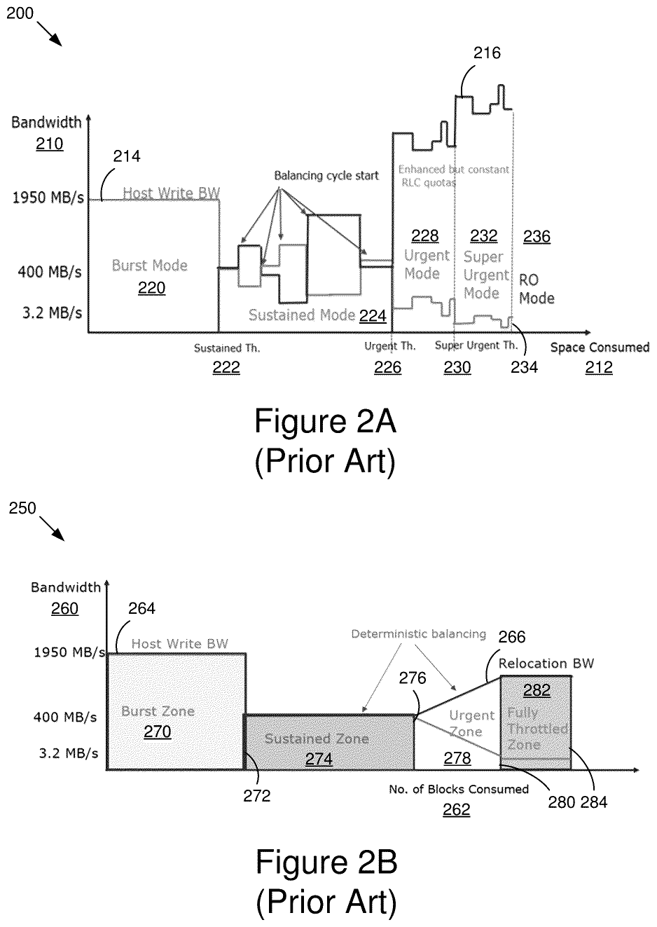

Referring to FIGS. 2A-2B, these figures illustrate two different approaches to bandwidth allocation in storage devices. More specifically, graphs 200 and 250 relate to how the fixed bandwidth of the backend memory interface to the non-volatile storage medium is allocated between storage operations for host storage commands and relocation storage operations used internally by the device for garbage collection to free up erase blocks for host writes.

FIG. 2A depicts a traditional storage device where the bandwidth fluctuates based on the Validity Count (VC) of the block selected for relocation. Graph 200 shows the relationship between bandwidth 210 on the y-axis (in megabytes (MB) stored per second) and space consumed 212 (e.g., percentage of total capacity) on the x-axis. Host write bandwidth line 214 and relocation bandwidth line 216 fluctuate across different operational modes. These modes may include: burst mode region 220, where there is sufficient available capacity that all bandwidth is allocated to host writes and no garbage collection has been initiated; sustained mode region 224, where garbage collection runs in parallel with host writes and allocations fluctuate based on the validity count of the blocks being recovered and the host write demands generally trying to maintain a guaranteed service level while sustainably recovering capacity through relocation; urgent mode region 228, where available capacity is increasingly locked in blocks with high validity counts that require greater relocation for lower yield of available capacity and may require prioritizing garbage collection over host writes; super urgent mode region 232, where little capacity remains and is scattered among high validity count blocks such that it is bandwidth intensive to recover blocks for host writes; and read only mode region 236, where the device triggers read only mode because no available capacity remains and garbage collection may not support incoming write operations. The transitions between these modes occur at the sustained threshold 222, urgent threshold 226, super urgent threshold 230, and read only threshold 234 respectively, which may each be based on a percentage of available capacity.

In contrast, FIG. 2B illustrates a deterministic storage device where the bandwidth allocation is more predictable. For example, the data storage device may use a rate matching technique implemented through a feedback control mechanism that tracks relocation efficiency versus host writes to match their rates in the sustained mode and linearly offset rates on the urgent mode. The graph 250 shows the relationship between bandwidth 260 (in MB/s) on the y-axis and blocks consumed 262 (e.g., percentage of total capacity) on the x-axis. Host write bandwidth line 264 and relocation bandwidth line 266 allocate the backend bandwidth of the memory interface, but do so in a more predictable (deterministic) fashion. Burst zone 270 operates similarly to burst mode 220 where all bandwidth is allocated to host writes until sustained threshold 272, such as 30% of capacity is reached. In sustained zone 274, the rate matching technique allows the system to select blocks for relocation that match the host write bandwidth supported until urgent threshold 276, such as 70% of capacity, is reached. Thus, sustained zone 274 provides an operating mode with more consistent host bandwidth allocation than sustained mode 224. In urgent zone 278, as in urgent mode 228, more bandwidth may be allocated to relocation, but using the feedback control mechanism the bandwidth may be reallocated linearly as capacity is consumed (or made available). Urgent zone 278 may be bounded by a fully throttled threshold 280, such as 90% of capacity. In fully throttled zone 282, a maximum allocation of relocation bandwidth is used, while supporting a minimal host write bandwidth until full capacity is reached and a read only threshold 284 is met. This approach provides more predictable bandwidth allocation as blocks are consumed, but with higher data processing overhead.

The load balancing technology described herein may support data storage devices operating using either bandwidth management technique. For example, storage devices supporting a host device may include a mix of storage devices configured with reactive balancing logic and deterministic balancing logic. As described below, these devices may report bandwidth states or modes and/or bandwidth capacity in different ways to the load balancer and the load balancer may be configured to determine capacity at bandwidth values differently for the different backend balancing logic used by the storage device. In some configurations, at least one data storage device of the plurality of data storage devices may be configured for constant bandwidth zones (deterministic bandwidth allocation) corresponding to the bandwidth state of that data storage device. The determination of the available capacity at bandwidth value for that data storage device may be based on an estimated operating period at that bandwidth state and/or the data storage device may include logic for estimating the capacity at bandwidth value based on estimator logic based on the historical performance of the rate matching technique at the current available capacity.

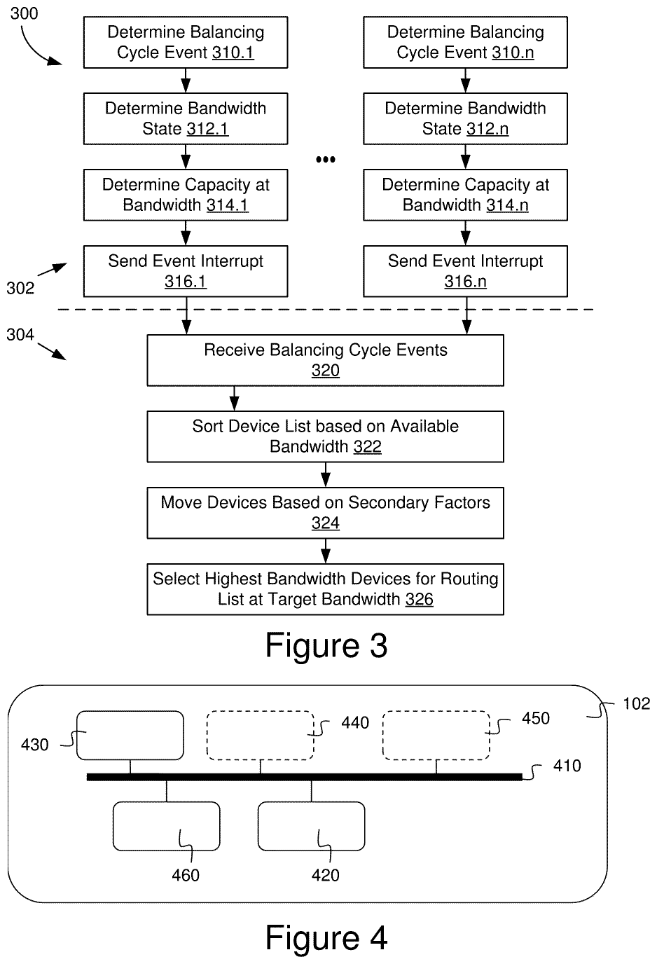

FIG. 3 illustrates a flowchart of a method 300 for managing storage device bandwidth and routing in a storage system for load balancing across storage devices. The method 300 may be executed by components of a storage system, such as the host device 102 and storage devices 120 shown in FIG. 1. This method may enable dynamic load balancing among multiple data storage devices using reported bandwidth. As a result, the storage system may maintain a constant host I/O bandwidth through the backend memory interfaces of the individual data storage devices. Data storage devices may execute blocks 310-316 as storage device operations 302 and a load balancer in a host device or storage controller may execute blocks 320-326 as host device operations 304. Any number of data storage devices may participate in method 300 as denoted by blocks 310.1-316.1 to 310.n-316.n.

At blocks 310.1-310.n, a balancing cycle event may be determined for each storage device. For example, the storage device controller 130 may monitor changes in available bandwidth for host storage operations and trigger a balancing cycle event when a significant change occurs.

At blocks 312.1-312.n, a bandwidth state may be determined for each storage device. For example, the storage manager 134 may analyze the current operating conditions and available capacity to determine the appropriate bandwidth state, such as burst, sustained, or urgent.

At blocks 314.1-314.n, a capacity at bandwidth value may be determined for each storage device. For example, the storage manager 134 may calculate the available capacity that can be sustained at the current bandwidth state based on factors such as valid data distribution and garbage collection efficiency.

At block 316.1-316.n, an event interrupt may be sent by any storage device having a load balancing event to notify the host device of changes in bandwidth availability. For example, the host interface 132 may generate and send an interrupt notification to the host device 102, including information about the new bandwidth state and capacity at bandwidth value. Host device operations 304 may be initiated in response to a bandwidth change notification from any of the storage devices.

At block 320, balancing cycle events may be received from the storage devices. For example, the host device 102 may receive interrupt notifications from one or more storage devices 120 through the storage interface bus 110 with a bandwidth change notification.

At block 322, a device list may be sorted based on available bandwidth. For example, the load balancer 116 in the host device 102 may sort the storage device identifiers based on the reported capacity at bandwidth values, such as from the highest capacity at bandwidth values to the lowest capacity at bandwidth values.

At block 324, devices may be moved in the list based on secondary factors. For example, the load balancer 116 may adjust the sorted list based on additional considerations such as bandwidth state, device priority, wear leveling, or specific application requirements.

At block 326, the highest bandwidth devices may be selected for the routing list at the target bandwidth. For example, the load balancer 116 may aggregate the available capacity at bandwidth values from the sorted list until the target bandwidth for the storage system is met, creating a subset of devices for routing host storage commands for the next operating period of the host device.

FIG. 4 shows a schematic representation of an example host device 102. Host device 102 may comprise a bus 410, a host processor 420, a host memory 430, one or more optional input units 440, one or more optional output units 450, and a communication interface 460. Bus 410 may include one or more conductors that permit communication among the components of host 102. Processor 420 may include one or more of any type of conventional processor or microprocessor that interprets and executes instructions. Host memory 430 may include a random access memory (RAM) or another type of dynamic storage device that stores information and instructions for execution by processor 420 and/or a read only memory (ROM) or another type of static storage device that stores static information and instructions for use by processor 420 and/or any suitable storage element such as a hard disc or a solid state storage element. An optional input unit 440 may include one or more conventional mechanisms that permit an operator to input information to host 102 such as a keyboard, a mouse, a pen, voice recognition and/or biometric mechanisms, etc. Optional output unit 450 may include one or more conventional mechanisms that output information to the operator, such as a display, a printer, a speaker, etc. Communication interface 460 may include any transceiver-like mechanism that enables host 102 to communicate with other devices and/or systems. In some embodiments, communication interface 460 may include one or more peripheral interfaces, such as a PCIe, USB, SD, SDXC, or other interface for connecting to storage device 120 and/or a network interface for communicating with storage devices 120 over a fabric network.

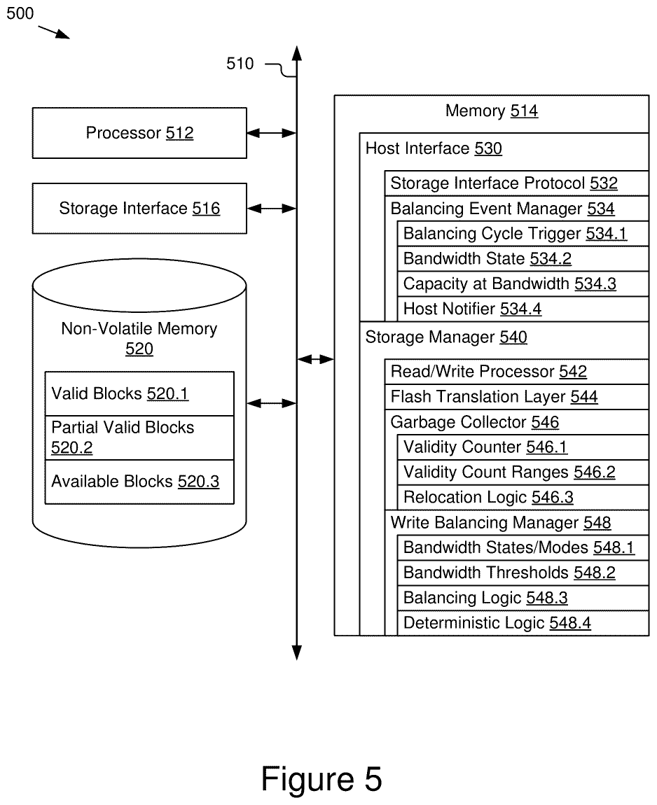

FIG. 5 schematically shows selected modules of a storage device 500 configured for reporting backend bandwidth for processing host storage commands to a host device for load balancing. Storage device 500 may incorporate elements and configurations similar to those shown in FIGS. 1-3. For example, storage device 500 may be a storage device configured as a storage device 120 in storage system 100, where the storage device includes: bus 510, processor 512, memory 514 (instantiating host interface 530 and storage manager 540), and storage interface 516 in storage device controller 130; and non-volatile memory 520 in NVM devices 140.

Storage device 500 may include a bus 510 interconnecting at least one processor 512, at least one memory 514, and at least one interface, such as storage interface 516. Bus 510 may include one or more conductors that permit communication among the components of storage device 500. Processor 512 may include one or more of any type of processor, processor cores, and/or microprocessor that interprets and executes instructions or operations, alone or in combination. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element (which may include a system portion allocated on non-volatile memory 520).

Storage interface 516 may include a physical interface for communication between a storage device and a host or client using an interface protocol that supports storage device access. For example, storage interface 516 may include a USB, SD, SDXC, PCIe, serial advanced technology attachment (SATA), serial attached small computer system interface (SCSI) (SAS), or similar storage interface connector supporting access to solid state media comprising non-volatile memory devices 520. In some embodiments, storage interface 516 may connect to or incorporate a network interface for connecting to a fabric network and/or other network. For example, storage interface 516 may connect to a network fabric interface through a backplane network and/or storage network interface controller supporting an NVMe-over-fabric (NVMeoF) protocol. In some embodiments, storage device 500, hosts, clients, and/or other components of the storage system may be configured as nodes in the NVMeoF topology and communicate using supported NVMe commands, such as NVMe telemetry commands. Storage interface 516 may include a physical port for engaging a device connector, such as device connector 110.2, to connect storage device 500 in a storage system, such as storage system 100.

Storage device 500 may include one or more non-volatile memory devices 520 configured to store data written to data blocks. For example, non-volatile memory devices 520 may include a plurality of flash memory packages organized as an addressable memory array. In some embodiments, non-volatile memory devices 520 may include NAND or NOR flash memory devices comprised of single level cells (SLC), multiple level cells (MLC), triple-level cells (TLC), quad-level cells (QLC), penta-level cells (PLC), etc. In some embodiments, non-volatile memory devices 520 may include the storage medium of a storage device, such as NVM devices 140 in storage devices 120. Non-volatile memory 520 may store host data in data blocks, such as erase blocks, that may be programmed during write operations and rendered invalid by subsequent write or delete operations. As a result, during any operating period, non-volatile memory 520 may include a combination of valid blocks 520.1 comprised of all valid data segments, partial valid blocks 520.2 that include a combination of valid data segments and invalid data segments in some percentage or count of valid data segments (validity count), and available blocks that have not been previously written or have no valid data segments following invalidation of the block and/or relocation of any remaining valid data segments to another data block during garbage collection. Available blocks 520.3 may correspond to the available capacity of the device to write new host data and/or relocate valid data from other blocks, while the invalid portion of partial valid blocks 520.2 may correspond to available capacity of the device that requires relocation to generate additional available block 520.3.

Storage device 500 may include a plurality of modules or subsystems that are stored and/or instantiated in memory 514 for execution by processor 512 as instructions or operations. For example, memory 514 may include a host interface 530 configured to receive, process, and respond to host data requests and/or management commands from client or host systems. Memory 514 may include storage manager 540 configured to manage storage and management operations to the media devices comprising non-volatile memory 520.

Host interface 530 may include an interface protocol and/or set of functions, parameters, and/or data structures for receiving, parsing, responding to, and otherwise managing host data requests from a host. For example, host interface 530 may include functions for receiving and processing host requests for reading, writing, modifying, or otherwise manipulating data blocks and their respective client or host data and/or metadata in accordance with host communication and storage protocols. Host interface 530 may also support administrative commands and/or management operations initiated by the host or the storage device, such as configuration changes, forced garbage collection, log access, firmware management, reporting of operational parameters, notification of bandwidth states and/or backend bandwidth changes, etc. For example, host interface 530 may support administrative command sets for configuring namespaces, queue control, log access, feature identification and configuration, security settings, and/or performance monitoring. In some embodiments, host interface 530 may enable direct memory access and/or access over NVMe protocols through storage interface 516.

In some embodiments, host interface 530 may include a plurality of hardware and/or software modules configured to use processor 512 and memory 514 to handle or manage defined operations of host interface 530. For example, host interface 530 may include a storage interface protocol 532 configured to comply with the physical, transport, and storage application protocols supported by the host for communication over storage interface 516. For example, storage interface protocol 532 may include USB, SD, SDXC, PCIe, NVMe, and/or other protocol compliant communication, command, and syntax functions, procedures, and data structures. In some embodiments, host interface 530 may include a balancing event manager 534 configured to provide functions, processing, and interfaces for reporting backend bandwidth changes to one or more host devices. In some embodiments, host interface 530 may include additional modules (not shown) for input/output (I/O) commands, buffer management, storage device configuration and management, and other host-side functions.

In some embodiments, balancing event manager 534 may include logic configured to receive an indication of backend bandwidth changes at the memory interface to non-volatile memory 520 and provide corresponding a notification interrupt to the host device. Balancing event manager 534 may include a balancing cycle trigger 534.1 that includes an interface and one or more rules for identifying bandwidth changes managed by storage manager 540. For example, balancing event manager 534 may monitor one or more registers corresponding to bandwidth state indicators 534.2 and/or capacity at bandwidth values 534.3 and/or receive function calls from storage manager 540 including or initiating access to such values. Bandwidth state indicators 534.2 may correspond to a current backend bandwidth mode or zone for allocating bandwidth between host write operations and relocation operations. For example, storage device 500 may be configured for one of the backend allocation approaches described above for FIGS. 2A and 2B and the state indicators may include burst, sustained, urgent, super urgent or fully throttled, and/or read only indicators for the corresponding modes or zones based on the current available free space or available blocks 520.3. Capacity at bandwidth values 534.3 may correspond to a calculated or estimated value for how long (in terms of capacity at a current bandwidth rate) the current bandwidth will be sustained by storage device 500. Capacity at bandwidth values 534.3 may include the new available host write bandwidth and the data write length for this guaranteed bandwidth (i.e., total backend bandwidth minus the relocation bandwidth for the current selected relocation source based on the validity count of that source). For reactive bandwidth allocations, the capacity at bandwidth value 534.3 may be determined based on the number of partial valid blocks at the selected validity count (or validity count range) being processed by garbage collector 546 for relocation and may be a parameter generated and maintained by garbage collector 546 and/or write balancing manager 548. For deterministic bandwidth allocations, the capacity at bandwidth value 534.3 may be determined based on an estimate of the sustained mode or fully throttled mode based on current capacity and distribution of validity counts and/or a rate of change for the urgent mode. Alternatively, no capacity at bandwidth value 534.3 may be calculated for devices using deterministic bandwidth allocations and an estimate factor may be applied by balancing event manager 534 or the receiving host to determine how the capacity at bandwidth value should be used for positioning the device in the sorted device list.

Host notifier 534.4 may include logic for generating a notification message to one or more host devices using storage interface protocol 532 and storage interface 516. For example, host notifier 534.4 may generate an interrupt notification through an administrative channel to the host device that includes a message type and parameters for bandwidth state indicator 534.2 and capacity at bandwidth value 534.3. In a configuration using NVMe, an NVMe asynchronous event request command from the administrative command set may be generated with an operation code (e.g., OxOC) corresponding to a vendor specific event defined to support the bandwidth change notification.

Storage manager 540 may include an interface protocol and/or set of functions, parameters, and data structures for reading, writing, and deleting data units in non-volatile memory devices 520. For example, storage manager 540 may include a read/write processor 542 for executing data operations to non-volatile memory 520 using a memory interface (not shown) for the physical non-volatile media devices. For example, PUT or write commands may be configured to write host data units or relocated data units to available blocks 520.3 in non-volatile memory devices 520 through a write processor. GET or read commands may be configured to read data from non-volatile memory 520 (in valid blocks 520.1 or partial valid blocks 520.2) through a read processor. DELETE commands may be configured to delete data from non-volatile memory devices 520, or at least mark a data location for deletion until a future garbage collection or similar operation actually deletes the data or reallocates the physical storage location to another purpose. In some embodiments, storage manager 540 may include flash translation layer (FTL) management 544, data state machine, read/write buffer management, NVM device interface protocols, NVM device management/maintenance, and other device-side functions. FTL management 544 may manage the logical to physical mapping of host LBAs to physical storage locations in non-volatile memory 520. FTL management 544 may maintain one or more FTL tables and/or algorithms for managing indirection between the LBAs and the corresponding data segments in the physical memory. FTL management 544 may also manage indications of valid and invalid data in partial valid blocks 520.2. FTL management 544 may update the FTL tables in response to relocation operations determined by garbage collector 546 to update the mapping of host LBAs to the new location of relocated valid data segments.

Storage manager 540 may include a garbage collector 546 including logic and data structures to consolidate valid data units into new programming blocks to enable invalid data units to be erased and allow their programming blocks to be reused. For example, garbage collector 546 may include logic for selecting programming blocks to be collected based on various data parameters, such as data age, valid fragment count, available capacity, etc., and may determine or access data and operating parameters related to such logic. Garbage collector 546 may include a validity counter 546.1 configured to determine validity counts for partial valid blocks 520.2 based on FTL data. In some configurations, validity counter 546.1 may allow garbage collector 546 to group data partial valid blocks 520.2 into validity count brackets or ranges 546.2 for ease in selecting specific blocks for garbage collection and predicting bandwidth and capacity at bandwidth. For example, validity count ranges 546.2 may group partial valid blocks 520.2 based on their respective validity counts into operating ranges, such as 10% increments (<10%, 11-20%, 21-30%, etc.). Relocation logic 546.3 may include on or more algorithms for selecting target partial valid blocks for garbage collection. For example, relocation logic 546.3 may include a selection algorithm based on a combination of physical location data (e.g., validity counts) and logical data units and extents for relocating host data in a way that both generates available blocks and support ongoing host read and write operations. In some embodiments, garbage collector 546 may include progressive logic that becomes more aggressive in reclaiming programming blocks as the number of available programming blocks decreases, as described below with regard to write balancing manager 548.

Storage manager 540 may include a write balancing manager 548 including logic and data structures to manage the backend bandwidth allocation between host operations and garbage collection operations. For example, write balancing manager 548 may manage the fixed bandwidth of the memory interface to non-volatile memory 520 according to a bandwidth allocation approach, such as the approaches in FIGS. 2A and 2B. Write balancing manager 548 may maintain a bandwidth state machine for bandwidth states or modes 548.1. For example, the bandwidth state machine may use the available capacity of available blocks 520.3 to determine whether storage device 500 is operating in burst mode, sustained mode, urgent mode, etc. The determination of which mode or zone storage device 500 is operating in may be determined based on comparing the available capacity (or, conversely, the capacity consumed or used) to various bandwidth thresholds 548.2. For example, the state machine may monitor the available or consumed capacity and compare it to a sustained threshold value, an urgent threshold value, etc. for changes in the bandwidth state, where the bandwidth state changes when a different threshold is met. As discussed above with regard to FIGS. 2A and 2B, write balancing manager 548 may be configured to manage the bandwidth allocations and backend bandwidth available to garbage collector 546 using a conventional balancing logic 548.3 (as described in FIG. 2A) or a deterministic balancing logic 548.4 (as described for FIG. 2B). Other approaches to bandwidth balancing logic are possible and corresponding logic for determining bandwidth states/modes and predicting or estimating capacity at bandwidth values may be used for reporting those bandwidth parameters through balancing event manager 534.

Storage manager 540 may include various functions that generate operational parameters, such as workload data, error rates, configuration parameters, physical parameters, storage parameters (e.g., aggregate storage space used/available/marked for garbage collection, wear leveling statistics, etc.), error logs, event logs, and other operational parameters that may be aggregated and reported through various interfaces, functions, or services.

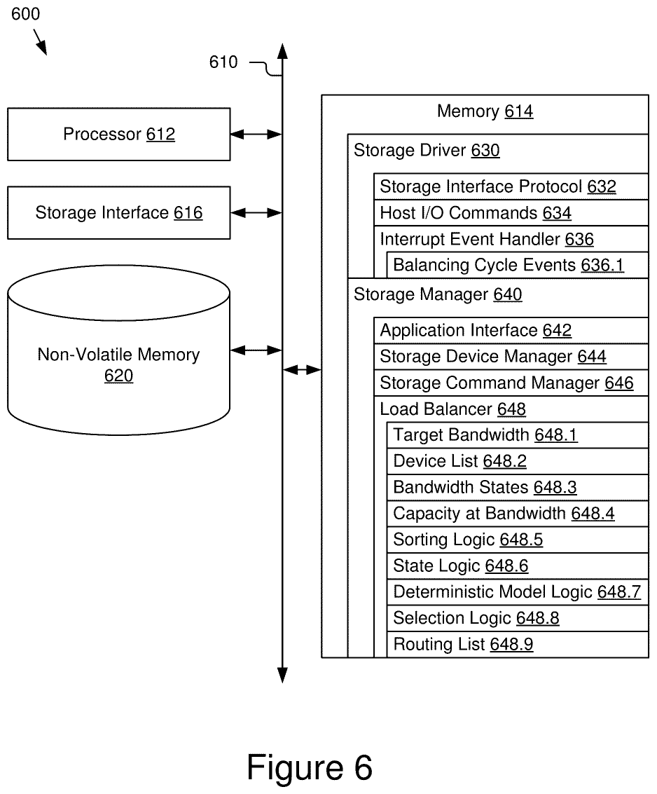

FIG. 6 schematically shows selected modules of a host device 600 configured for receiving backend bandwidth for processing host storage commands from a group of storage devices for load balancing. Host device 600 may incorporate elements and configurations similar to those shown in FIGS. 1-4. For example, host device 600 may be a host device configured as host device 102 in storage system 100, where the host device includes bus 610, processor 612, memory 614 (instantiating storage driver 630 and host storage manager 640), storage interface 616, and non-volatile memory 520.

Host device 600 may include a bus 610 interconnecting at least one processor 612, at least one memory 614, and at least one interface, such as storage interface 616. Bus 610 may include one or more conductors that permit communication among the components of host device 600. Processor 612 may include one or more of any type of processor, processor cores, and/or microprocessor that interprets and executes instructions or operations, alone or in combination. Memory 614 may include a random access memory (RAM) or another type of dynamic storage device that stores information and instructions for execution by processor 612 and/or a read only memory (ROM) or another type of static storage device that stores static information and instructions for use by processor 612 and/or any suitable storage element such as a hard disk or a solid state storage element. Host device 600 may include one or more non-volatile memory devices 620, which may include a local SSD, HDD, etc., used for local storage.

Storage interface 616 may include a physical interface for communication between a storage device and a host or client using an interface protocol that supports storage device access. For example, storage interface 616 may include a USB, SD, SDXC, PCIe, SATA, SAS, or similar storage interface connector supporting access to a plurality of data storage devices. In some embodiments, storage interface 616 may connect to or incorporate a network interface for connecting to a fabric network and/or other network. For example, storage interface 616 may connect to a network fabric interface through a backplane network and/or storage network interface controller supporting an NVMeoF protocol. In some embodiments, storage device, host device 600, clients, and/or other components of the storage system may be configured as nodes in the NVMeoF topology and communicate using supported NVMe commands. Storage interface 616 may include one or more physical ports for engaging a host connector, such as host connector 110.1, to connect host device 600 in a storage system, such as storage system 100.

Host device 600 may include a plurality of modules or subsystems that are stored and/or instantiated in memory 614 for execution by processor 612 as instructions or operations. For example, memory 614 may include a storage driver 630 configured to send, process, and receive results from host data requests and/or management commands from host device 600 to one or more storage devices. Memory 514 may include host storage manager 640 configured to manage storage operations for one or more applications that are processed through storage driver 630 to the connected data storage devices.

Storage driver 630 may include an interface protocol and/or set of functions, parameters, and/or data structures for sending host data requests to and receiving responses from storage devices through storage interface 616. For example, storage driver 630 may provide an interface for receiving and processing application data requests from the operating system of host device 600 for reading, writing, modifying, or otherwise manipulating data blocks and their respective host data and/or metadata in accordance with storage device communication and storage protocols. Storage driver 630 may also support administrative commands and/or management operations initiated by the host or the storage device, such as configuration changes, forced garbage collection, log access, firmware management, reporting of operational parameters, notification of bandwidth states and/or backend bandwidth changes, etc. For example, storage driver 630 may support administrative command sets for configuring namespaces, queue control, log access, feature identification and configuration, security settings, and/or performance monitoring. In some embodiments, storage driver 630 may enable direct memory access and/or access over NVMe protocols through storage interface 616.

In some embodiments, storage driver 630 may include a plurality of hardware and/or software modules configured to use processor 612 and memory 614 to handle or manage defined operations of storage driver 630. For example, storage driver 630 may include a storage interface protocol 632 configured to comply with the physical, transport, and storage application protocols supported by the storage devices or storage system for communication over storage interface 616. For example, storage interface protocol 632 may include USB, SD, SDXC, PCIe, NVMe, and/or other protocol compliant communication, command, and syntax functions, procedures, and data structures. Storage driver 630 may include a host I/O command processor 634 including logic to receive storage commands according to the operating system protocols from applications operating on or through host device 600 and map them to corresponding host storage commands to one or more data storage devices. Host I/O command processor 634 may use on or more command queues allocated to specific storage devices to manage the host storage commands allocated to each storage device. Storage driver 630 may include an interrupt event handler 636 including logic to receive interrupt events from the storage devices that are not directly responsive to a storage command. For example, interrupt event handler 636 may operate as part of an administrative command set and administrative channel according to storage interface protocol 632 and receive and parse interrupt event messages from the storage devices. In some configurations, interrupt event handler 636 may include logic for receiving balancing cycle events 636.1 from the storage devices for initiating a load balancing cycle in in host storage manager 640. For example, interrupt event handler 6363 may monitor and parse interrupt notifications through the administrative channel that include a message type and parameters for bandwidth state indicator 534.2 and capacity at bandwidth value 534.3 from storage device 500. In a configuration using NVMe, an NVMe asynchronous event request command from the administrative command set may be received with an operation code (e.g., OxOC) corresponding to a vendor specific event defined to support the bandwidth change notification. Responsive to receiving a bandwidth change notification, interrupt event handler 636 may initiate a load balancing cycle by sending a corresponding event or call to storage manager 640. In some embodiments, storage driver 630 may include additional modules (not shown) for buffer management, storage device configuration and management, and other storage device-side functions.

Host storage manager 640 may include an interface protocol and/or set of functions, parameters, and data structures for operating in conjunction with storage driver 630 (as well other components of the operating system and/or other applications) to manage the use of multiple storage devices for host storage operations. For example, host storage manager 640 may include storage management features integrated with the host operating system or embodied in a storage management application that operates in conjunction with one or more features of the operating system and storage driver 630.

Host storage manager 640 may include an application interface 642 for receiving and managing application-level storage access commands, translating them into host storage commands compatible with storage driver 630, and managing their allocation among storage devices and their corresponding command queues. For example, application interface 642 may receive read, write, and delete commands according to file system protocols within host device 600 and parse those file system calls into one or more host storage commands to be processed by connected storage devices.

Host storage manager 640 may include a storage device manager 644 that includes logic and data structures for managing the host connections to a group of data storage devices. For example, storage device manager 644 may use storage interface protocols to discover and establish host connections with a set of data storage devices connected to or accessible by host device 600 using peripheral bus and/or network protocols. Storage device manager 644 may include a data structure for managing and monitoring those host storage connections, including identifying each storage device connected in this manner, as well as identifying parameters for each storage device, which may include storage device identifiers and additional parameters such as device type, capacity, host interface I/O, I/O service level, etc. In some configurations, storage device manager 644 may use these parameters to populate a device list 648.2 used by load balancer 648.

Host storage manager 640 may include a storage command manager 646 that includes logic and data structures for aggregating host storage commands from different applications to manage their priority, status, response, error states, and other features for processing the storage commands using the storage devices. For example, storage command manager 646 may include logic for prioritizing and managing application storage calls and organizing the corresponding host storage commands for execution by the storage devices. This may include buffer, command queue, and service level management for assuring consistent and timely processing of host storage commands to meet system performance needs and prevent application-layer bottlenecks. For example, in high throughput and/or data intensive applications, such as data processing for machine learning training, massively parallel processing, and/or model execution for real-time decision-making, maintaining constant throughput of host storage commands for close timing of data processing intermediates and prevention of bottlenecking may be supported by a need for constant bandwidth from the collective efforts of the storage devices connected to host device 600. In some configurations, host storage manager 640 may include and storage command manager 646 may rely on a load balancer 648 for meeting fixed bandwidth performance that includes the total processing time and capacity of the group of data storage devices.

Host storage manager 640 may include load balancer 648 including logic and data structures to allocate each host storage command from storage command manager 646 to a specific storage device and corresponding host I/O command queues through storage driver 630. For example, load balancer 648 may determine the collective bandwidth states and bandwidth at capacity of the connected storage devices and select a subset of them to support the current storage processing needs of host device 600. In some configurations, this load balancing may be initiated in cycles that determine the subset of storage devices for routing host storage commands for a given operating period and these operating periods may extend from determination of a routing list for the current reported backend bandwidth of the connected storage devices until notification of a change in backend bandwidth is received from one of the storage devices to trigger reevaluation of the routing list. In some configurations, load balancer 648 may be configured for a specific target bandwidth 648.1 determined to provide the consistent processing for the applications of host device 600. For example, target bandwidth 648.1 may include a host I/O rate (e.g., MB/s) to be maintained by the system and load balancer 648 may be configured to maintain a predictive and reactive ability regarding the volume of commands that can reliably be handled by the collective storage devices to match a subset of storage devices at any given time based on their backend bandwidth.

To manage the monitoring and selection of storage devices for consistent backend bandwidth, load balancer 648 may maintain and/or access a device list 648.2 including storage device identifiers for each storage device connected to host device 600. For example, load balancer 648 may include or access a device list data structure, such as a device table, based on the data maintained by storage device manager 644. Device list 648.2 may determine the total set of storage devices available to host device 600 during any given operating period and load balancer 648 may use device list 648.2 to organize current bandwidth parameters against the storage device identifiers. For example, bandwidth parameters received from the storage devices through interrupt event handler 636 and/or calculated based on the received parameters may be stored and updated in device list 648.2. In some configurations, bandwidth state indicators 648.3, capacity at bandwidth values 648.4, and/or other backend bandwidth parameters may be stored for each storage device in an entry indexed by its unique storage device identifier. Device list 648.2 and reported bandwidth parameters from the storage devices may be used by load balancer 648 to determine the routing subset for any given operating period.

Load balancer 648 may include sorting logic 648.5 configured to sort device list 648.2 according to capacity at bandwidth values 648.4. For example, sorting logic 648.5 may include a highest-to-lowest sort routine directed to capacity at bandwidth values 648.4 and reorganizing an order of the storage device identifiers in device list 648.2 to generate a sorted list of storage device identifiers. In some configurations, sorting logic 648.5 may implement secondary sort rules configured to rearrange storage device order based on secondary considerations. For example, load balancer 648 may be configured to use other parameters to move the positions of storage device identifiers and change the order in which they are selected from the sorted list for selecting routing list 648.9. In some configurations, secondary sorting rules may include state logic 648.6 configured to prioritize or deprioritize specific bandwidth states for the selection routing list 648.9. For example, state logic 648.6 may move storage devices in the burst state below storage devices in the sustained state regardless of their capacity at bandwidth value. This may cause load balancer 648 to favor storage devices that will balance garbage collection with host operations for more consistent performance across the group of devices and across operating periods. State logic 648.6 may also prioritize devices in sustained mode ahead of devices in urgent states, to allow those devices to dedicate more resources to garbage collection and return to sustained states where possible. Devices in burst mode may be positioned ahead of devices in urgent states (urgent, super urgent, or fully throttled) and, as bandwidth at capacity needs push some devices into urgent states, selection logic 648.8 may select storage devices in the burst state. In some configurations, deterministic model logic 648.7 may use an estimated capacity at bandwidth value for initial placement of storage devices using deterministic bandwidth allocation because the storage device may not reliably provide the duration per data amount that can be written (which is based on a internal garbage collection feedback look that may involve multiple relocation source blocks). Deterministic model logic 648.7 may further move storage devices that are using deterministic models in the sort order because their capacity at bandwidth values are less reliable than those using reactive balance models, particularly in urgent state.

Load balancer 648 may include selection logic 648.8 configured for selecting a subset of storage devices to receive host storage commands in the next operating period. For example, load balancer 648 may select a portion of the storage devices with the highest bandwidth at capacity values based on the sorted device list (with any adjustments based on secondary sorting rules). Selection logic 648.8 may return a routing list 548.9 that includes the storage device identifiers of the subset of data storage devices to receive host storage commands in the next operating period. For example, routing list 648.9 may be a data structure or set of parameters returned to storage command manager 6464 for use in allocating host storage commands among the storage devices and their command queues. In some configurations, target bandwidth 648.1 may provide a threshold metric for determining the set of storage devices. For example, starting from the top of the sorted storage device list, selection logic 648.8 may select device identifiers and aggregate the corresponding bandwidth at capacity values to achieve an aggregate bandwidth at capacity value that meets the target bandwidth for the volume of host storage commands being handled by storage manager 640. Once target bandwidth 648.1 is met, the subset of storage devices on routing list 648.9 is returned for use in allocating host storage commands and continues to operate until another balancing cycle event is initiated by receipt of a bandwidth change notification. Note that meeting the target bandwidth may include at least equaling and may include exceeding the target bandwidth value, but not exceeding by more than the bandwidth at capacity value of the next storage device in the sorted list. Also, because of the size of host data writes (which may include block sizes of 1 gigabyte or more), device balancing triggers infrequently (e.g., at an average of once every several 100 MB of data transferred) and bandwidth change notifications (and reshuffling of the routing list during the triggered load balancing cycles) creates negligible processing or messaging overhead relative to the data transfers and backend storage operations themselves.

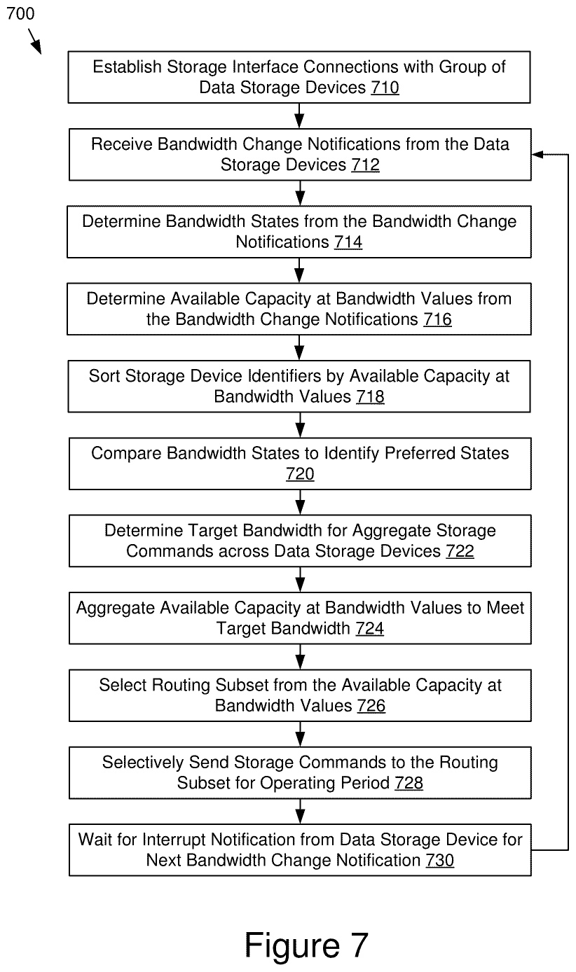

FIG. 7 illustrates a flowchart of a method 700 for load balancing storage operations across multiple data storage devices. Method 700 may be executed by components of a host device, such as host device 102 shown in FIG. 1, particularly load balancer 116 and storage manager 114, and/or host device 600 shown in FIG. 6. This method may enable dynamic load balancing and efficient allocation of storage commands among multiple storage devices based on their reported backing bandwidth capabilities. As a result, the host device may maintain consistent performance and optimize utilization of available storage resources.

At block 710, storage interface connections may be established with a group of data storage devices. For example, storage interface 616 of the host device 600 may initiate and configure communication links with multiple storage devices through a storage interface bus.

At block 712, bandwidth change notifications may be received from the data storage devices. For example, interrupt event handler 636 may process asynchronous notifications sent by the storage devices through the storage interface 616, indicating changes in their backend bandwidth availability.

At block 714, bandwidth states may be determined from the received bandwidth change notifications. For example, load balancer 648 may parse the received notifications to categorize each storage device into a specific bandwidth state, such as burst, sustained, or urgent mode.

At block 716, available capacity at bandwidth values may be determined from the bandwidth change notifications. For example, load balancer 648 may extract or calculate the amount of data that can be written at the current bandwidth state for each storage device based on the information provided in the notifications.

At block 718, storage device identifiers may be sorted by the available capacity at bandwidth values. For example, sorting logic 648.5 of load balancer 648 may arrange device list 648.2 in descending order based on the calculated capacity at bandwidth values.

At block 720, bandwidth states may be compared to identify preferred states among the devices. For example, state logic 648.7 may analyze the bandwidth states of all devices and prioritize those in sustained mode over those in burst or urgent modes.

At block 722, a target bandwidth for aggregate storage commands across the data storage devices may be determined. For example, load balancer 648 may calculate a desired total bandwidth based on current application requirements and system performance goals and/or may be configured with a target bandwidth the host device is meant to maintain.

At block 724, the available capacity at bandwidth values may be aggregated to meet the target bandwidth. For example, load balancer 648 may sum up the capacity at bandwidth values from the sorted device list until the cumulative bandwidth meets or exceeds the target bandwidth.

At block 726, a routing subset may be selected from the available capacity at bandwidth values. For example, load balancer 648 may choose the top N devices from the sorted and aggregated list to form the routing subset, where N is the number of devices needed to meet the target bandwidth.

At block 728, storage commands may be selectively sent to the routing subset for an operating period. For example, storage command manager 646 may distribute incoming storage operations only to the devices in the routing subset, utilizing their reported available bandwidth and allowing other storage devices to allocate more resources to garbage collection until their bandwidth state and/or bandwidth at capacity change (and the host device is notified).

At block 730, the system may wait for an interrupt notification from a data storage device for the next bandwidth change notification. For example, interrupt event handler 636 may enter a waiting state, ready to process the next asynchronous notification from any storage device, which would trigger a new load balancing cycle.

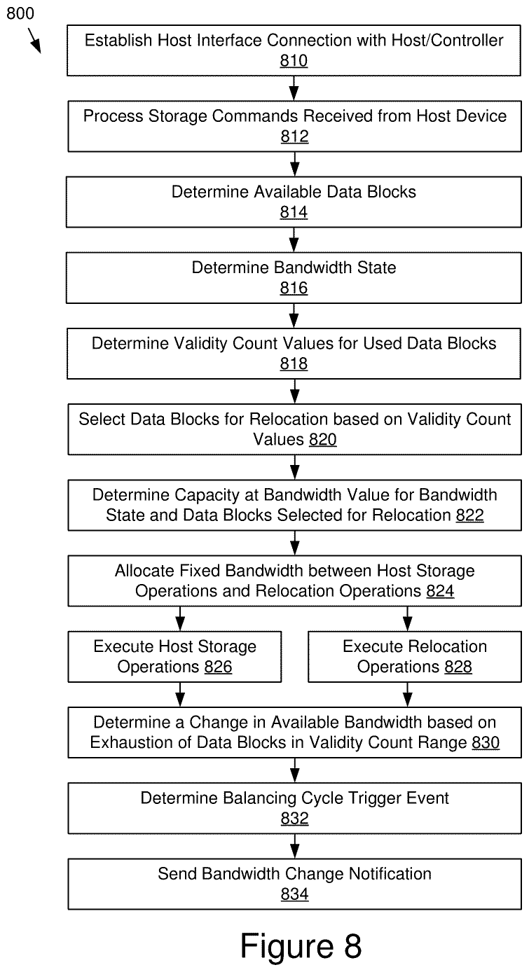

FIG. 8 illustrates a flowchart of a method 800 for managing and reporting on backend bandwidth in a data storage device. Method 800 may be executed by components of a storage device, such as storage devices 120 shown in FIG. 1 and/or storage device 500 shown in FIG. 5. This method may enable dynamic management of storage operations while considering bandwidth allocation, data block validity, and relocation operations. As a result, the storage device may adapt to changes in data block availability and validity, triggering notifications to the host when significant changes in backend bandwidth occur.

At block 810, a host interface connection may be established with a host or controller. For example, host interface 530 of storage device 500 may initiate (or respond to) and configure a communication link with a host device through storage interface 516.

At block 812, storage commands received from the host device may be processed. For example, host interface 530 may parse the host storage commands into backend host storage operations to be executed by read/write processor 542 for read, write, or delete operations.

At block 814, available data blocks may be determined. For example, storage manager 540 may monitor the storage operations to non-volatile memory 520 to track available blocks 520.3 that can be used for new data storage.

At block 816, the bandwidth state may be determined. For example, the write balancing manager 548 may assess the current operating conditions and available capacity to determine the appropriate bandwidth state, such as burst, sustained, or urgent.

At block 818, validity count values for used data blocks may be determined. For example, validity counter 546.1 of the garbage collector 546 may analyze the partial valid blocks 520.2 to determine the amount of valid and invalid data in each block.

At block 820, data blocks may be selected for relocation. For example, relocation logic 546.3 of the garbage collector 546 may choose blocks for garbage collection based on their validity count values and other criteria.

At block 822, the capacity at bandwidth value for the current bandwidth state and data blocks selected for relocation may be determined. For example, write balancing manager 548 may calculate the backend bandwidth needed based on the selected blocks for relocation and determine the data write length of the corresponding remaining bandwidth for the host storage operations to provide the capacity guaranteed at the current bandwidth.

At block 824, fixed bandwidth may be allocated between host storage operations and relocation operations. For example, the write balancing manager 548 may divide the available bandwidth between processing host commands and performing garbage collection using the blocks selected for relocation.

At block 826, host storage operations may be executed. For example, the read/write processor 542 may perform read or write operations requested by the host device using the allocated bandwidth.

At block 828, relocation operations may be executed. For example, the garbage collector 546 may move valid data from selected blocks to new locations, freeing up space for future write operations. The backend storage operations for blocks 826 and 828 may be executed in parallel sharing the available backend bandwidth of the memory interface to the non-volatile memory devices.

At block 830, a change in available bandwidth may be determined based on the completion of the relocation operations for the selected blocks and/or the exhaustion of blocks in the same validity count range. For example, the write balancing manager 548 may detect when the relocation operations based on the current selected blocks and corresponding validity counts completes.

At block 832, a balancing cycle trigger event may be determined. For example, the balancing event manager 534 may determine the selection of a next set of blocks for relocation with a different validity count that will require different allocations of backend processing, a new capacity at bandwidth value, and/or a change in bandwidth state as significant changes in bandwidth availability that warrant notifying the host device.

At block 834, a bandwidth change notification may be sent. For example, host notifier 534.4 may generate and send an interrupt notification to the host device, informing it of the updated bandwidth state and capacity at bandwidth value.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user's computing device, partly on a user's computing device, as a stand-alone software package, partly on a user's computing device and partly on a remote computing device, or entirely on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A system comprising:
a storage interface configured to provide storage commands to a plurality of data storage devices;
at least one memory; and
at least one processor configured to, alone or in combination:
receive, from the plurality of data storage devices, bandwidth change notifications corresponding to changes in a host storage operation bandwidth for a non-volatile storage medium of that data storage device;
determine, based on the bandwidth change notifications, an available capacity at bandwidth value for that data storage device;
sort, based on the available capacity at bandwidth values, storage device identifiers for the plurality of data storage devices;
select, based on the sorted storage device identifiers, a routing subset of the plurality of data storage devices, wherein a number of devices in the routing subset of the plurality of data storage devices is less than a number of devices in the plurality of data storage devices; and
selectively send host storage commands to the routing subset of the plurality of data storage devices.

2. The system of claim 1, wherein:
the bandwidth change notifications comprise a bandwidth state for that data storage device; and
selecting the routing subset of the plurality of data storage devices is based on a comparison of the bandwidth states of the plurality of data storage devices.

3. The system of claim 2, wherein:
at least one data storage device of the plurality of data storage devices is configured for constant bandwidth zones corresponding to the bandwidth state of that data storage device; and
determining the available capacity at bandwidth value for that at least one data storage device is based on an estimated operating period at that bandwidth state.

4. The system of claim 1, wherein the bandwidth change notifications comprise the available capacity at bandwidth value for that data storage device.

5. The system of claim 1, wherein the at least one processor is further configured to, alone or in combination:
receive, from a corresponding data storage device of the plurality of data storage devices, each bandwidth change notification as an interrupt notification based on a balancing cycle trigger determined by the corresponding data storage device;
initiate, responsive to receiving at least one bandwidth change notification, sorting the storage device identifiers and selecting the routing subset; and
use, for an operating period extending until receiving another bandwidth change notification, the routing subset for selectively sending host storage commands.

6. The system of claim 1, wherein the at least one processor is further configured to, alone or in combination:
determine a target bandwidth for aggregate storage operations across the plurality of data storage devices; and
aggregate the available capacity at bandwidth values for sorted storage device identifiers until the target bandwidth is met to select the routing subset of the plurality of data storage devices.

7. The system of claim 1, further comprising:
the plurality of data storage devices, wherein each data storage device of the plurality of data storage devices comprises:
a host interface for that data storage device configured for communication with the at least one processor;
the non-volatile storage medium for that data storage device;
at least one storage device processor for that data storage device configured to, alone or in combination:
process storage commands received by the host interface;
execute storage operations to the non-volatile storage medium with a fixed bandwidth divided between host storage operations and relocation operations;
determine a change in available bandwidth for host storage operations; and
send the bandwidth change notification through the host interface.

8. The system of claim 7, wherein the at least one storage device processor for that data storage device is further configured to, alone or in combination:
determine, for a plurality of data blocks in the non-volatile storage medium, validity count values corresponding to an amount of valid and invalid data in that data block;
select, based on the validity count values, data blocks for relocation operations;
determine, based on the validity count values and a number of data blocks for relocation, the capacity at bandwidth value; and
include the capacity at bandwidth value in the bandwidth change notification.

9. The system of claim 7, wherein the at least one storage device processor for that data storage device is further configured to, alone or in combination:
determine, based on available data blocks, a bandwidth state;
determine, based on the change in the available bandwidth for host storage operations, a balancing cycle trigger;
initiate, responsive to the balancing cycle trigger, sending the bandwidth change notification; and
include the bandwidth state in the bandwidth change notification.

10. The system of claim 1, further comprising:
a host device comprising:
the storage interface;
the at least one memory; and
the at least one processor, wherein the plurality of data storage device support storage commands from a plurality of host devices.

11. A computer-implemented method, comprising:
receiving, from a plurality of data storage devices, bandwidth change notifications corresponding to changes in a host storage operation bandwidth for a non-volatile storage medium of that data storage device;
determining, based on the bandwidth change notifications, an available capacity at bandwidth value for that data storage device;
sorting, based on the available capacity at bandwidth values, storage device identifiers for the plurality of data storage devices;
selecting, based on the sorted storage device identifiers, a routing subset of the plurality of data storage devices, wherein a number of devices in the routing subset of the plurality of data storage devices is less than a number of devices in the plurality of data storage devices; and
selectively sending host storage commands to the routing subset of the plurality of data storage devices.

12. The computer-implemented method of claim 11, further comprising:
determining, from the bandwidth change notifications, a bandwidth state for that data storage device; and
comparing the bandwidth states of the plurality of data storage devices to select the routing subset of the plurality of data storage devices.

13. The computer-implemented method of claim 12, wherein:
at least one data storage device of the plurality of data storage devices is configured for constant bandwidth zones corresponding to the bandwidth state of that data storage device; and
determining the available capacity at bandwidth value for that at least one data storage device is based on an estimated operating period at that bandwidth state.

14. The computer-implemented method of claim 11, wherein the bandwidth change notifications comprise the available capacity at bandwidth value for that data storage device.

15. The computer-implemented method of claim 11, further comprising:
receiving, from a corresponding data storage device of the plurality of data storage devices, each bandwidth change notification as an interrupt notification based on a balancing cycle trigger determined by the corresponding data storage device;
initiating, responsive to receiving at least one bandwidth change notification, sorting the storage device identifiers and selecting the routing subset; and
using, for an operating period extending until receiving another bandwidth change notification, the routing subset for selectively sending host storage commands.

16. The computer-implemented method of claim 11, further comprising:
determining a target bandwidth for aggregate storage operations across the plurality of data storage devices; and
aggregating the available capacity at bandwidth values for sorted storage device identifiers until the target bandwidth is met to select the routing subset of the plurality of data storage devices.

17. The computer-implemented method of claim 11, further comprising:
processing, by a data storage device from the plurality of data storage devices, storage commands received from at least one host device;
executing, by the data storage device, storage operations to the non-volatile storage medium based on a fixed bandwidth divided between host storage operations and relocation operations;
determining, by the data storage device, a change in available bandwidth for host storage operations; and
sending, by the data storage device, the bandwidth change notification to the at least one host device.

18. The computer-implemented method of claim 17, further comprising:
determining, by the data storage device and for a plurality of data blocks in the non-volatile storage medium, validity count values corresponding to an amount of valid and invalid data in that data block;
selecting, by the data storage device and based on the validity count values, data blocks for relocation operations;
determining, by the data storage device and based on the validity count values and a number of data blocks for relocation, the capacity at bandwidth value; and
including, by the data storage device, the capacity at bandwidth value in the bandwidth change notification.

19. The computer-implemented method of claim 17, further comprising:
determining, by the data storage device and based on available data blocks, a bandwidth state;
determining, by the data storage device and based on the change in the available bandwidth for host storage operations, a balancing cycle trigger;
initiating, by the data storage device and responsive to the balancing cycle trigger, sending the bandwidth change notification; and
including, by the data storage device, the bandwidth state in the bandwidth change notification.

20. A system, comprising:
means for receiving, from a plurality of data storage devices, bandwidth change notifications corresponding to changes in a host storage operation bandwidth for a non-volatile storage medium of that data storage device;
means for determining, based on the bandwidth change notifications, an available capacity at bandwidth value for that data storage device;
means for sorting, based on the available capacity at bandwidth values, storage device identifiers for the plurality of data storage devices;
means for selecting, based on the sorted storage device identifiers, a routing subset of the plurality of data storage devices, wherein a number of devices in the routing subset of the plurality of data storage devices is less than a number of devices in the plurality of data storage devices; and
means for selectively sending host storage commands to the routing subset of the plurality of data storage devices.
